(19) United States
(12) Patent Application Publication
(10) Pub. No.: US 2003/0229809 A1
(43) Pub. Date: Dec. 11, 2003

(54) Transparent proxy server

(76) Inventors: Asaf Wexler, Raanana (IL); Ariel Frydman, Foster City, CA (US); Daniel Yaghil, Tel-Aviv (IL); Shaul Levi, San Francisco, CA (US)

Correspondence Address: William H. Dippert, Esq., Reed Smith LLP, 29th Floor, 599 Lexington Avenue, New York, NY, 10022-7650, US

(21) Appl. No.: 10/422,607

(22) Filed: Apr. 24, 2003

Related U.S. Application Data
(63) Continuation of application No. PCT/IL00/00683, filed on Oct. 25, 2000.
(63) Continuation-in-part of application No. 09/365,185, filed on Aug. 2, 1999.
Application No. 09/365,185 is a continuation of application No. PCT/IL99/00203, filed on Apr. 15, 1999.
(60) Provisional application No. 60/129,483, filed on Apr. 15, 1999.

(51) Int. Cl. G06F 15/173; G06F 11/30

(52) U.S. Cl. 713/201; 709/223

(57) ABSTRACT

A method of handling packets by a proxy server. The method includes receiving a packet, requesting to establish a connection of a connection based protocol, not carrying an IP address of the proxy server in an IP destination address field of the packet, and establishing a connection between the proxy server and a source of the received packet as listed in the source IP address of the received packet.

### RELATED APPLICATIONS

The present application is a continuation in part (CIP) of U.S. patent application Ser. No. 09/365,185, filed Aug. 2, 1999, which is a continuation of PCT Application PCT/IL99/00203, filed Apr. 15, 1999 and which claims the benefit under 35 U.S.C 119(e) of U.S. Provisional application No. 60/129,483, filed Apr. 15, 1999. The disclosure of all these documents is incorporated herein by reference.

### FIELD OF THE INVENTION

The present invention relates to communication networks and in particular to proxy servers.

### BACKGROUND OF THE INVENTION

Various mediation tools are used to mediate between networks, for example between an organization network, e.g., a Web farm, and an external network, e.g., the Internet. Some of these tools, operate in layer 3, e.g., routers which change the IP addresses of packets between internal and external addresses. Other tools, such as firewalls, examine packets in various layers, e.g., layer 2, layer 3, layer 4 and/or the application layer, discard unauthorized packets and optionally change layer-3 packet information in a manner similar to the above described routers. Further tools which mediate between networks, are cache servers which store copies of files passing through them. When a cache server identifies a request for a file it has stored, the cache server does not forward the request to its destination but rather transmits the file to the originator of the request. In some cases, the cache server transmits a query to the destination of the request to determine whether the file has changed, and accordingly determines whether to intercept the request.

Additional tools that mediate between networks are proxy servers which perform various manipulation tasks on the data transmitted from and/or to a local network. Generally, packets directed to the local network are transmitted with a destination IP address of the proxy server, which manipulates the data, if necessary and forwards the manipulated data to a selected entity of the local network. Packets from the proxy server to the network carry the destination IP address of the selected entity and the source IP address of the proxy server.

A technical overview of Resonate, titled “Resonate Central Dispatch TCP Connection Hop” by Glen Kosaka and a Resonate white paper “Central Dispatch 3.0”, December 1999, the disclosures of which documents are incorporated herein by reference, describe use of a plurality of Web servers which operate in coordination to perform a mutual task.

The installation of mediation tools generally requires configuration of one or more organization computers as well as configuration of the proxy servers. These configuration tasks are time consuming, even for network managers. The configuration burden naturally increases with the number of Web servers used.

Some mediation tools, which only minimally alter the traffic flow, operate transparently, i.e., without the routers on either of sides of the tool being aware of the presence of the mediation tool. Transparent mediation tools include firewalls that simply discard packets which do not adhere to security rules, as described, for example, in a white paper of SunScreen titled Secure Net 3.0, the disclosure of which is incorporated herein by reference.

/www.sitaranetworks.con/product.html and /www.sitaranetworks.com/prod_dep.html, available on Oct. 5, 2000, the disclosures of which documents are incorporated herein by reference, describe a quality of service (QoS) mediation tool which performs caching and traffic management, transparently. The traffic management includes TCP shaping by altering the window size of the packets passing through the switch and changing the QoS fields of the packets.

### SUMMARY OF THE INVENTION

An aspect of some embodiments of the present invention relates to a transparent proxy server that intercepts packets which are directed in layer-2 and/or layer-3 to one or more other entities (e.g., host, routers, switches) and establishes separate layer-4 sessions with the source and destination of the packets it intercepts. Unlike regular proxy servers, a transparent proxy server handles packets which are not directed to the proxy server in layer 3, i.e., do not carry a destination IP address which belongs to the transparent proxy server. Using a transparent proxy server eliminates the need to configure the network elements with the identity of the proxy server. In addition, a transparent server is less vulnerable to external intrusions.

In some embodiments of the invention, the transparent proxy server does not change the layer-3 information of the packets and/or does not perform a routing operation, i.e., does not reduce the TTL of the packets. Alternatively or additionally, the proxy server does not have an IP address, at least for the ports through which it performs its proxy tasks. Optionally, the ports of the proxy server have configured addresses but these addresses are not used in packets forwarded by the proxy server. Optionally, packets generated by the proxy server are forwarded with a source IP address of a different entity. In some embodiments of the invention, the entities neighboring the transparent proxy server are not aware in layer 3 of the existence of the proxy server.

In some embodiments of the invention, the transparent proxy server changes the application layer information (e.g., web site contents, files) of at least some of the packets it forwards. Optionally, the proxy server changes portions of the packets it forwards while leaving at least some of the original information from the source intact. For example, the proxy server may replace information from a censored external Web site with predetermined Web site information or may correct spelling errors in information provided by a Web site.

In some embodiments of the invention, the proxy server changes at least one of the port fields of at least some of the packets it forwards.

In some embodiments of the invention, the proxy server is connected between two links which connect to one or more entities which are not aware, at least in layer-3, that the proxy server is situated between them. Optionally, the proxy server identifies itself to the entities on each link as recognizing and/or owning the IP addresses of the entities on the other link. Alternatively or additionally, the proxy server mirrors ARP (address resolution protocol) and RIP (routing information protocol) packets and/or other topology determination packets it receives, between its ports which connect to the two computers. In some embodiments of the invention, the proxy server does not have layer-3 addresses on its ports which connect to the two links. Thus, the number of IP addresses required by the organization using the proxy server is not increased because of the use of the proxy. Alternatively, the proxy server does not have layer-3 (e.g., IP) addresses in any of its ports.

An aspect of some embodiments of the present invention relates to a transparency (hardware and/or software) module which converts an existing mediation tool, e.g., an existing proxy server, or an existing farm of mediation tools into a transparent proxy server or transparent proxy farm. In some embodiments of the invention, the transparency module changes packets received from the networks serviced by the mediation tool before they are provided to the mediation tool. In addition, the transparency module optionally changes packets transmitted by the mediation tool to the networks. The changing is performed, such that the entities receiving packets from the mediation tool are not aware of the mediation tool and the mediation tool is not aware of the fact that it is transparent. For example, when the mediation tool changes the source and/or destination IP address of packet it handles, the transparency module optionally changes the addresses back to their original values so that the entities on the networks connected to the mediation tool do not see that the addresses changed. In some embodiments of the invention, the transparency module also changes the addresses of packets received from the networks to addresses expected by the mediation tool, e.g., the addresses with which the proxy server sent its packets.

In some embodiments of the invention, the transparency module marks the packets provided to the mediation tool with a unique identification such that it is easy to identify the packet after it is altered by the mediation tool. Optionally, the marking of the packets includes changing the values of one or more fields of the packets which are not altered by the mediation tool, e.g., the source port of the packets. In some embodiments of the invention, the transparency module also marks packets forwarded to a local network serviced by the mediation tool, so as to easily identify the response packets generated by the local network responsive to the forwarded packets. Optionally, the same marking is used for the packets provided to the mediation tool and the packets forwarded from the mediation tool to the local network.

In some embodiments of the invention, the transparency module is located on the same computer or switch as the mediation tool. Alternatively or additionally, the transparency module is located on a separate physical unit.

An aspect of some embodiments of the present invention relates to a transparent farm of transparent mediation tools, which split between them the handling of the traffic passing through them on a specific link. In some embodiments of the invention, the transparent mediation tools are situated in parallel such that all the mediation tools receive the same traffic from the specific link. The transparent farm includes a plurality of mediation tools, such as proxy servers, which may operate in coordination. In some embodiments of the invention, one of the mediation tools also operates as a dispatcher which intercepts all the packets forwarded on the link and distributes the packets between the plurality of mediation tools for handling. Optionally, the dispatcher itself handles, in accordance with the tasks of the mediation tools, some of the received packets. In some embodiments of the invention, the dispatcher is chosen using a distributed algorithm from between some or all of the plurality of mediation tools. Alternatively, the dispatcher does not handle the received packets and only distributes the packets between the other mediation tools of the transparent farm.

In some embodiments of the invention, two different dispatchers are used one for each direction of flow of packets and/or for different IP address ranges of the packets in order to reduce the load carried by any specific dispatcher.

In some embodiments of the invention, substantially all the handlers perform the same tasks, and the use of a plurality of handlers is directed to coping with large amounts of traffic. Alternatively or additionally, some of the handlers perform different tasks and the dispatcher forwards the packets to the specific handlers according to the specific tasks they must undergo. Optionally, some of the packets are passed through a few handlers one after the other.

There is therefore provided in accordance with an embodiment of the invention, a method of handling packets by a proxy server, including receiving a packet, requesting to establish a connection of a connection based protocol, not carrying an IP address of the proxy server in an IP destination address field of the packet and establishing a connection between the proxy server and a source of the received packet, as listed in the source IP address of the received packet.

Optionally, the method includes establishing a connection between the proxy server and a destination of the received packet, as listed in the destination IP address of the received packet. Optionally, the method includes receiving one or more additional packets belonging to the same session as the packet requesting establishment of the connection. In some embodiments of the invention, the received one or more additional packets carry application layer data and including altering the application layer data and forwarding the altered data to the destination of the one or more received packets.

Possibly, altering the data includes leaving at least some of the received application layer data unaltered. Optionally, altering the data includes correcting spelling or grammatical errors in the application layer data.

In some embodiments of the invention, forwarding the altered data to the destination of the one or more packets includes forwarding in one or more packets carrying at least one different port field value different than in the received one or more additional packets. Optionally, forwarding the altered data to the destination of the one or more packets includes forwarding in one or more packets carrying the same destination IP address as the received packet requesting establishment of the connection. In some embodiments of the invention, the proxy server includes a transparency module and a proxy module and wherein receiving the packet requesting to establish a connection includes receiving by the transparency module, modifying one or more fields of the packet by the transparency module and providing the modified packet to the proxy module of the proxy server. Optionally, the transparency module modifies one or more of the IP address fields and port fields of the packet and/or the source port field of the packet. In some embodiments of the invention, the request packet is received through a physical port of the proxy server, which does not have a configured IP address which is used as a source IP address for packets transmitted through the physical port.

There is further provided in accordance with an embodiment of the invention, a method of handling packets by a proxy server, including receiving, by the proxy server, one or more packets of a specific session, not carrying an IP address of the proxy server in their IP destination address field, altering a portion of the application layer data of the received one or more packets, while leaving at least some of the data intact, and forwarding the altered application layer data to the destination of the received one or more packets as identified by the IP destination address field of the one or more received packets.

Optionally, forwarding the altered application layer data includes forwarding in packets carrying the same IP addresses and/or time to live (TTL) value as the received one or more packets. In some embodiments of the invention, forwarding the altered application layer data includes forwarding in packets having at least one different port field value different from the value in the respective field in the received one or more packets. Possibly, altering the portion of the application layer data includes replacing an erroneous portion of a Web page by a replacement portion.

There is further provided in accordance with an embodiment of the invention, a method of handling packets by a proxy server, including receiving, by the proxy server, one or more packets of a specific session, not carrying an IP address of the proxy server in their IP destination address field, altering at least one of the port fields of the received one or more packets, and forwarding the altered one or more packets to the destination of the received one or more packets as identified by the IP destination address field of the one or more received packets. Optionally, forwarding the altered one or more packets includes forwarding with the same IP addresses and/or TTL values as the received one or more packets. In some embodiments of the invention, forwarding the altered one or more packets includes forwarding in accordance with a splicing procedure.

There is further provided in accordance with an embodiment of the invention, a method of converting a mediation tool, located on a network path, into a transparent tool including providing a packet transmitted on the path, to a mediation module of the tool, receiving from the mediation module one or more packets generated in response to the provided packet, and altering one or more fields of the one or more packets received from the mediation module, so that the altered fields have the same values as the packet provided to the mediation module.

Optionally, the method includes receiving the packet from the path, the received packet from the path having a destination IP address not belonging to the mediation tool. Optionally, the method includes altering one or more fields of the packet provided to the mediation module. Possibly, altering the one or more fields includes inserting to the packet an identification value which is used in identifying the one or more packets generated by the mediation tool in response to the provided packet. In some embodiments of the invention, inserting an identification value includes changing a source port field of the provided packet.

Optionally, altering the one or more fields includes altering one or more fields to values expected by the mediation tool, such that the mediation tool operates without being aware of the transparency.

There is further provided in accordance with an embodiment of the invention, a method of handling packets passing along a path by a plurality of mediation tools, including providing, by each of the plurality of mediation tools, at least some of the packets passing along the path and not carrying an IP address of any of the mediation tools in their IP destination address field, to a layer four or above module of the mediation tool, and forwarding packets carrying the same destination IP address as the provided packets, responsive to at least some of the provided packets.

Possibly, forwarding packets carrying the same destination IP address as the provided packets includes forwarding at least one of the packets with the same application layer data as a provided packet. Alternatively or additionally, forwarding packets carrying the same destination IP address as the provided packets includes forwarding at least one of the packets with some application layer data from a provided packet and some application layer data not included in a provided packet of the same session.

Optionally, forwarding packets carrying the same destination IP address as the provided packets includes forwarding packets having at least one port value different from the respective provided packet. Optionally, providing, by each of the mediation tools, at least some of the packets to a layer four or above module, includes receiving all the packets passing on the path by each of the mediation tools and each mediation tool determining which packets to provide to its layer four or above module, responsive to a layer 3 or above content of the packets. In some embodiments of the invention, determining, by each of the mediation tools, which packets to provide to the layer four or above module includes determining responsive to the source or destination IP address of the packet. Optionally, determining, by each of the mediation tools, which packets to provide to the layer four or above module includes determining responsive to predetermined rules. Optionally, providing, by each of the mediation tools, at least some of the packets to a layer four or above module, includes receiving all the packets passing on the path by a dispatcher, determining by the dispatcher whether the packet requires handling and if required selecting one or more of the mediation tools to perform the handling and forwarding the packet to the selected mediation tool.

In some embodiments of the invention, forwarding the packet to the selected mediation tool includes forwarding in layer 2. Optionally, forwarding the packet to the selected mediation tool includes forwarding with a source MAC address not belonging to the dispatcher. Possibly, the dispatcher includes one of the mediation tools. Possibly, the method includes selecting a mediation tool to operate as the dispatcher using a distributed algorithm.

There is further provided in accordance with an embodiment of the invention, a transparent mediation farm, including a plurality of mediation tools which provide at least some of the packets they receive to a layer four or above module of the mediation tool for processing and which forward packets carrying the same destination IP address as the provided packets, responsive to at least some of the provided packets, and communication links which connect the plurality of mediation tools. Optionally, at least one of the mediation tools may operate as a dispatcher which receives packets passing on the communication links, determines which of the packets should be forwarded to one or more of the mediation tools and forwards the packets to the respective mediation tools.

Optionally, at least one of the mediation tools includes a proxy server. Optionally, all the mediation tools perform the same tasks. Alternatively, at least one of the mediation tools performs at least one different task than one other of the mediation tools. Possibly, at least one of the mediation tools generates packets with a source address not belonging to the mediation tool or to any of the packets recently received by the mediation tool. In some embodiments of the invention, at least one of the mediation tools is configured with an IP address which is not used in any of the packets forwarded by the mediation tool.

There is further provided in accordance with an embodiment of the invention, a transparent mediation tool, including a mediation module; and a transparency module which receives packets from the mediation module, alters one or more IP address fields of the received packets so that the IP addresses of the altered packets do not reveal that the packets were handled by the mediation module and forwards the altered packets on a communication link. Optionally, the mediation module includes a proxy server module. In some embodiments of the invention, the mediation module changes at least some of the application layer data of the packets. Possibly, the transparency module receives packets transmitted on the communication link and provides the packets from the link to the mediation tool, and wherein the transparency module alters the IP addresses of packets received from the mediation tool to the IP addresses of packets of the same session provided to the mediation tool.

In some embodiments of the invention, the transparency module alters at least one of the port fields of at least some of the packets provided to the mediation module. Possibly, the transparency module comprises a software module and/or a hardware module.

There is further provided in accordance with an embodiment of the invention, a proxy server, including an input interface which receives a packet, requesting to establish a connection of a connection based protocol, not carrying an IP address of the proxy server in an IP destination address field of the packet; and a proxy module which establishes a connection between the proxy server and a source of the received packet, as listed in the source IP address of the received packet. Optionally, the proxy module establishes a connection between the proxy server and a destination of the received packet, as listed in the destination IP address of the received packet.

There is further provided in accordance with an embodiment of the invention, a proxy server, including an input interface which receives one or more packets of a specific session, not carrying an IP address of the proxy server in their IP destination address field, and a proxy module which alters a portion of the application layer data of the received one or more packets, while leaving at least some of the data intact, and an output interface which forwards the altered application layer data to the destination of the received one or more packets as identified by the IP destination address field of the one or more received packets.

Optionally, the proxy module manages a list of packet sessions which it is interested in receiving and packets received by the proxy module are compared to the list to determine whether they are directed to the proxy module.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in winch they appear, in which:

FIG. 1 is a schematic block diagram of a local network which uses a transparent proxy server, in accordance with an exemplary embodiment of the present invention;

FIG. 2 is a flowchart of the actions performed by a transparency module upon receiving a packet, in accordance with an embodiment of the present invention;

FIG. 3 is a schematic illustration of a table array used by a transparency module of a proxy server, in accordance with an embodiment of the present invention;

FIG. 4 is a flowchart of the acts performed in handling ARP packets, in accordance with an embodiment of the present invention; and

FIG. 5 is a schematic block diagram of a Web site server farm including a transparent proxy farm, in accordance with an embodiment of the present invention.

### DETAILED DESCRIPTION OF EMBODIMENTS

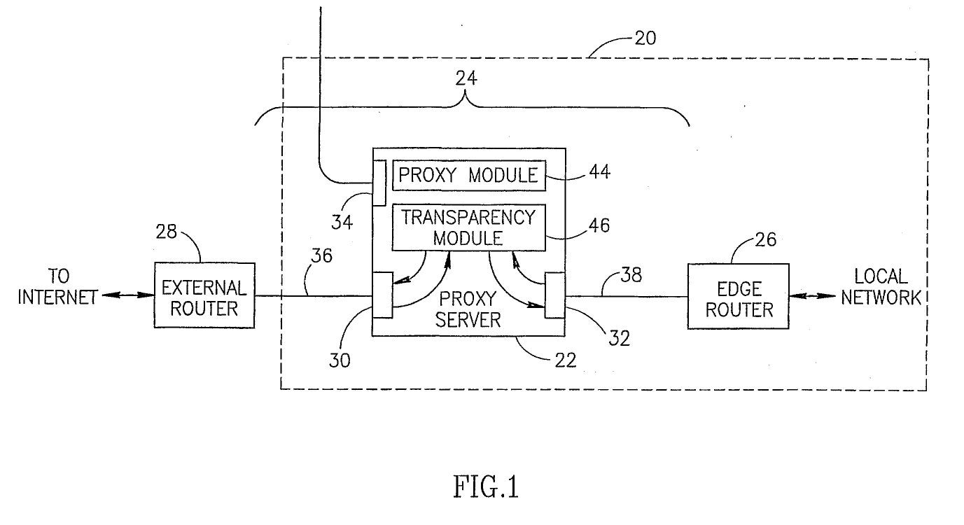

FIG. 1 is a schematic block diagram of a local network 20 which uses a transparent proxy server 22, in accordance with an exemplary embodiment of the present invention. Local network 20 comprises an edge router 26 which connects to an external network, such as the Internet, through a path 24 which leads to an external router 28. Proxy server 22 is placed along path 24 and connects to edge router 26 over a link 36 and to external router 28 over a link 38. Optionally, all the traffic transmitted between local network 20 and external networks passes through proxy server 22 and there are no parallel paths to path 24. Proxy server 22 comprises an outbound physical port 30 and an inbound physical port 32 which are connected to links 36 and 38, respectively. It is noted that the terms inbound and outbound for ports 30 and 32 are used for clarity only and do not relate to the functions of the ports, as both ports may both transmit and receive packets.

In some embodiments of the invention, edge router 26 and external router 28 do not require any specific configuration when proxy server 22 is installed, in order to operate with the proxy server. In some embodiments of the invention, packets received by proxy server 22 are forwarded with the same IP addresses as they are received. Thus, edge router 26 and/or external router 28 are not aware, in layer-3, of the presence of proxy server 22 along path 24. Optionally, edge router 26 and/or external router 28 are not aware of the presence of proxy server 22 along path 24, in layer-2.

In some embodiments of the invention, ports 30 and 32 of proxy server 22 do not have layer-3, e.g., IP, addresses. Alternatively, proxy server 22 relates the same way to packets directed to an IP address of the proxy server 22 and to packets not directed to the proxy server.

Optionally, proxy server 22 manages a list of packets it is expecting to receive and only packets which match an entry of the list are handled as directed to the proxy server. In some embodiments of the invention, the only packets in the list are packets which are generated responsive to packets generated by proxy server 22.

In some embodiments of the invention, packets generated by proxy server 22 are transmitted with a pseudo source IP address, such that remote entities are not aware of a real IP address of proxy server 22. In some embodiments of the invention, the pseudo source IP address is configured into proxy server 22 by the user. Optionally, the pseudo address comprises an inter-network address, e.g., 10.x.x.x, an unused address, and/or an address of a remote host which never (or nearly never) sent packets (or is not expected to send packets) which passed through proxy server 22. Alternatively, proxy server 22 uses one of the IP addresses of packets passing through it as the pseudo source IP address, for example a source address from the opposite direction to which the packet is transmitted. For example, when proxy server 22 needs to transmit a packet through inbound port 32 it uses a source address of a packet it received through outbound port 30.

Optionally, when proxy server 22 transmits a packet it generated, for example an alert packet, it marks the packet in a manner that will allow identification of responses thereto. Optionally, proxy server 22 uses a specific source port which identifies the packets.

When a packet directed to the pseudo address and the specific source port is received, proxy server 22 determines whether the packet is a response to a packet it transmitted, and if not the packet is discarded. Optionally, when a packet having the specific port as its source port is received by proxy server 22, the proxy server changes the source port of the packet to a different value, such that packets received responsive thereto will not be interpreted as packets directed to the proxy server. Alternatively, proxy server 22 changes the source port only in packets whose IP address is the pseudo source IP address and the source port is the specific source port.

Alternatively, the ports of proxy server 22 have IP addresses but they discard messages directed to their IP addresses, unless the messages are responses to specific transmitted messages.

Optionally, proxy server 22 comprises one or more additional ports, e.g. port 34, through which messages may be sent to the proxy server, without requiring that the messages be responses to specific packets transmitted by the proxy server. Alternatively, proxy server 22 may only be programmed directly, for example through a console (not shown). Thus, remote fiddling with the configuration of proxy server 22 is substantially impossible.

In some embodiments of the invention, proxy server 22 is configured with the IP addresses of the entities in the local network. Thus, proxy server 22 can operate as a security verifier and prevent entrance of packets not directed to an entity of the local network. Optionally, proxy server 22 is also configured with the MAC addresses of some or all of the entities in the local network. Optionally, proxy server 22 operates in a Promiscuous mode in which all packets are passed to a processor of proxy server 22 that determines if the packets match any of the configured MAC addresses. Alternatively, proxy server 22 does not require any configuration for proper forwarding of the packets it receives and monitors. Rather, proxy server 22 determines the addresses by listening to the traffic passing through it.

In some embodiments of the invention, proxy server 22 comprises a plurality of separate modules which operate independently. Optionally, proxy server 22 comprises a proxy module 44 that performs the general tasks of proxy server 22, and a transparency module 46 which manages the transparent transmission and reception of packets by server proxy 22. In some embodiments of the invention, transparency module 46 may be added to substantially any proxy server, thus converting the proxy server into a transparent proxy server. In some embodiments of the invention, transparency module 46 is located within the TCP/IP stack of proxy server 22.

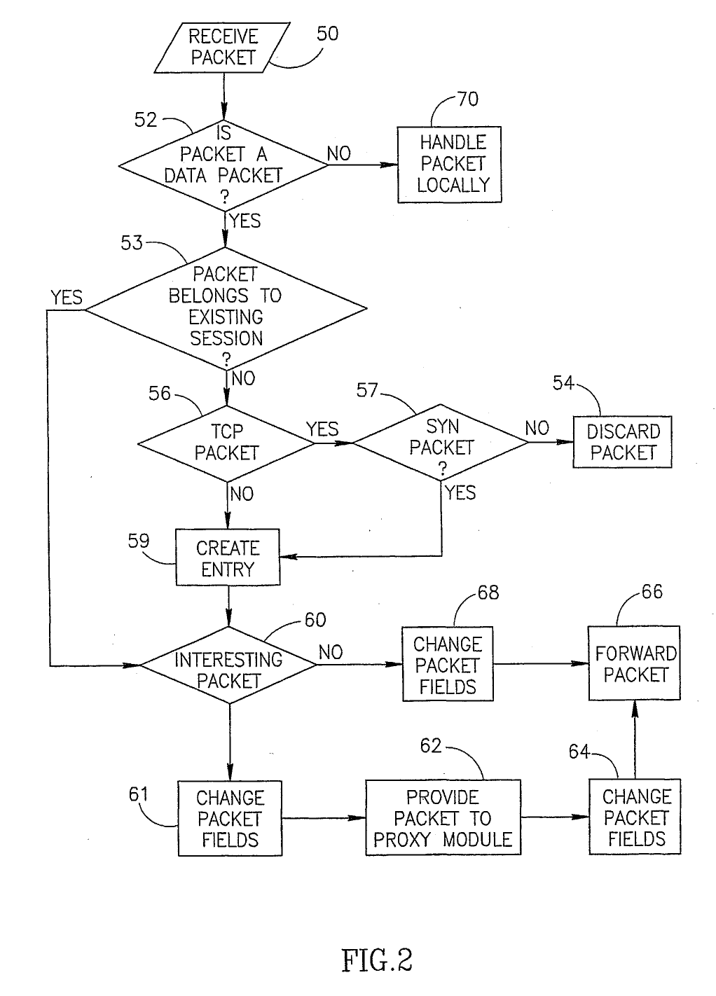

FIG. 2 is a flowchart of the actions performed by transparency module 46 upon receiving (50) a packet, in accordance with an embodiment of the present invention. In some embodiments of the invention, if (52) the packet is a data packet, transparency module 46 compares the packet to entries which represent current sessions passing through the proxy server. If (53) the packet belongs to an existing session, transparency module 46 determines (60) whether the packet is interesting (i.e., is to be handled by the proxy server) and operates accordingly, as described hereinbelow. In some embodiments of the invention, HTTP packets, for example, are interesting packets while ping packets, for example, are uninteresting packets. Possibly, all data packets passing through proxy server 22 are considered interesting. Alternatively, only packets belonging to specific protocols, such as HTTP and/or FTP, are considered interesting. Further alternatively, substantially all TCP packets are considered interesting.

If (53), however, the packet does not belong to an existing session, transparency module 46 creates (59) a respective entry for the session to which the packet belongs. Optionally, transparency module 46 checks the validity of the packet before creating an entry. For example, if the packet is a TCP packet, transparency module 46 checks whether the packet is a beginning packet of a session, i.e., the SYN bit is set. In some embodiments of the invention, after creating (59) the entry, transparency module 46 determines (60) whether the packet is interesting.

If the packet is interesting, the packet is provided (62) to proxy module 44 for processing in accordance with the specific tasks of proxy server 22. In some embodiments of the invention, the processing performed by proxy module 44 includes performing cache server tasks and/or virus checking. Alternatively or additionally, the processing performed by proxy module 44 includes WAP conversion, quality of service (QoS) tagging, access control, correctness checks, load balancing, traffic redirection, sniffing (i.e., passing certain packets to a computer in addition to their destination) and/or specific packet counting. Further alternatively or additionally, the processing performed by proxy module 44 includes any other proxy tasks, such as a content verification server that verifies that files transmitted from a Web protected site include proper verification stamps and/or performs other content checks. Further alternatively or additionally, the processing performed by proxy module 44 includes any of the tasks described in U.S. Provisional application No. 60/129,483, filed Apr. 15, 1999, U.S. patent application Ser. No. 09/365,185, filed Aug. 2, 1999, and/or PCT application PCT/IL99/00203, filed Apr. 15, 1999, the disclosures of which documents are incorporated herein by reference. It is noted that the processing of the packet by proxy module 44 may leave the packet intact or may change portions of the packet.

In some embodiments of the invention, proxy module 44 establishes, for packets of connection based protocols, e.g., the TCP protocol, connections with both the source and destination of the packet, and splices the connections to each other. By establishing; the separate connections with the source and destination, the buffering of the data is performed in a layer higher than layer 3 and not in layer 3 which is not usually adequate for buffering large amounts of data. The term splicing refers to a procedure in which proxy server 22 forwards packets received on one of the spliced connections, on the other spliced connection. For example, when a request to establish a connection is received through outbound port 30, proxy server 32 responds through outbound port 30 with a response packet for establishing the connection. In addition, proxy server 22 sends a request to establish a connection to the destination of the received packet, through inbound port 32. In some embodiments of the invention, the forwarding performed by proxy server 22 in accordance with the splicing includes changing the identification numbers of the TCP headers of the packets.

In some embodiments of the invention, proxy module 44 determines for the packets it receives whether they are directed to the proxy module. Optionally, as described above, proxy module 44 manages a list of expected packets and packets matching entries of the list are handled as directed to the proxy module.

In some embodiments of the invention, one or more of the fields of the packet are changed (61), as described hereinbelow, before the packet is provided (62) to proxy module 44. Optionally, the changing is performed in order to mark the packet as belonging to a specific session, so that the packet returned by proxy module 44 as well as possible additional packets of the same session are easily identified by transparency module 46. The marking of packets is required because in some cases proxy module 44 may change one or more other fields of the packets it receives, for example, proxy module 44 may replace the entire contents of some of the packets. In some embodiments of the invention, the marking is also used to mark packets from clients being transmitted to a Web server of the internal network. This marking allows easy identification of packets produced as responses by the Web server. Optionally, packets are marked by replacing the source port of the packet to a pseudo port value. Packets sent in response to the packet with the replaced port will carry the pseudo port in their destination port field and will thus be easily identified by transparency module 46.

Alternatively or additionally, the changing (61) of the packets is performed so that the provided packets coincide with the expectations of proxy module 44, which is not necessarily aware of the transparency of proxy server 22.

After the packet is processed by proxy module 44, the packet (optionally after being changed or replaced by proxy module 44) is returned to transparency module 46. The packet received from proxy module 44 is forwarded (66) through the port (30 or 32) opposite the port (32 or 30) through which the packet was received. In some embodiments of the invention, before forwarding the packet, transparency module 46 changes (64) one or more fields of the packet. The changing of one or more fields is optionally performed in order to remove implanted markings of packets and/or in order to return one or more field values changed by proxy module 44 back to their original value, such that proxy server 22 operates transparently. For example, as described hereinbelow in detail, the changing (64) may include replacing the source and/or destination IP addresses of the packets as given by proxy module 44 to the original IP addresses of the packets. Similarly, the changing (61) of one or more fields of packets provided to proxy module 44 optionally includes changing the source and/or destination IP addresses of the packets to the values which proxy module 44 uses.

In some embodiments of the invention, uninteresting packets are forwarded (66) through the opposite port, without first providing (62) the packets to proxy module 44. Optionally, transparency module 44 changes (68) one or more of the fields of the uninteresting packets, e.g., the source port field of packets directed to the local network, for marking purposes.

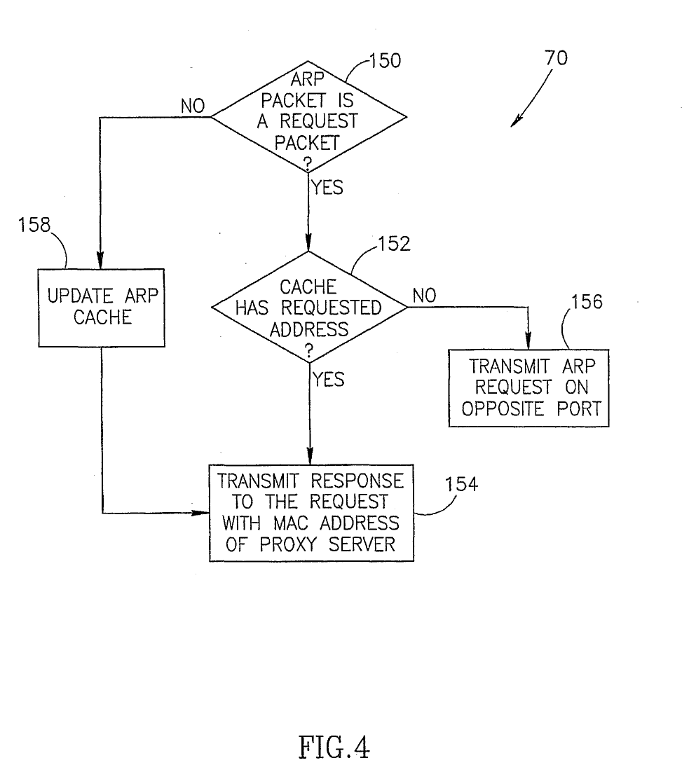

If (52) the received packet is not a data packet, for example the packet is an address resolution protocol (ARP) packet, transparency module 46 handles (70) the packet locally without forwarding the packet through the opposite port, for example using known ARP spoofing methods. An exemplary procedure for handling ARP packets is described hereinbelow with reference to FIG. 4.

In some embodiments of the invention, transparency module 46 also determines whether the packet is legal (i.e., adheres to security rules) and if the packet is not legal it is discarded, or past to a security processor, by transparency module 46. The determination is optionally performed using any of the operation methods of firewalls known in the art. In an exemplary embodiment of the invention, packets received through inbound port 32, i.e., from the local network, are discarded unless their IP source address is one of the addresses configured into proxy server 22 as belonging to the local network. Alternatively or additionally, packets received through outbound port 30 are discarded unless their destination IP address is one of the addresses configured into proxy server 22 as belonging to the local network. Optionally, TCP packets which belong to a connection not recognized by transparency module 46 are discarded, if they are not a request to establish a connection, i.e., a packet with the SYN bit set.

Alternatively or additionally, security checks if required are performed by proxy module 44 using any method known in the art.

Referring in more detail to determining (52) whether the received packet is a data packet, in some embodiments of the invention, substantially all IP packets are considered data packets. ARP packets and/or topology determination packets, such as RIP packets, are considered non-data packets. In some embodiments of the invention, all packets which are not in accordance with specific protocols that are handled locally by transparency module 46 are considered data packets.

Referring in more detail to forwarding (66, FIG. 2) the packet, in some embodiments of the invention, proxy server 22 forwards packets with the same IP source and/or destination addresses with which they were received. Furthermore, in some embodiments of the invention, proxy server 22 does not reduce the value of the time to live (TTL) of the packets it forwards. In some embodiments of the invention, proxy server 22 forwards the packets with the destination MAC address corresponding to the destination IP address of the packet and the source MAC address of the port through which the packet is forwarded, as is known in the art.

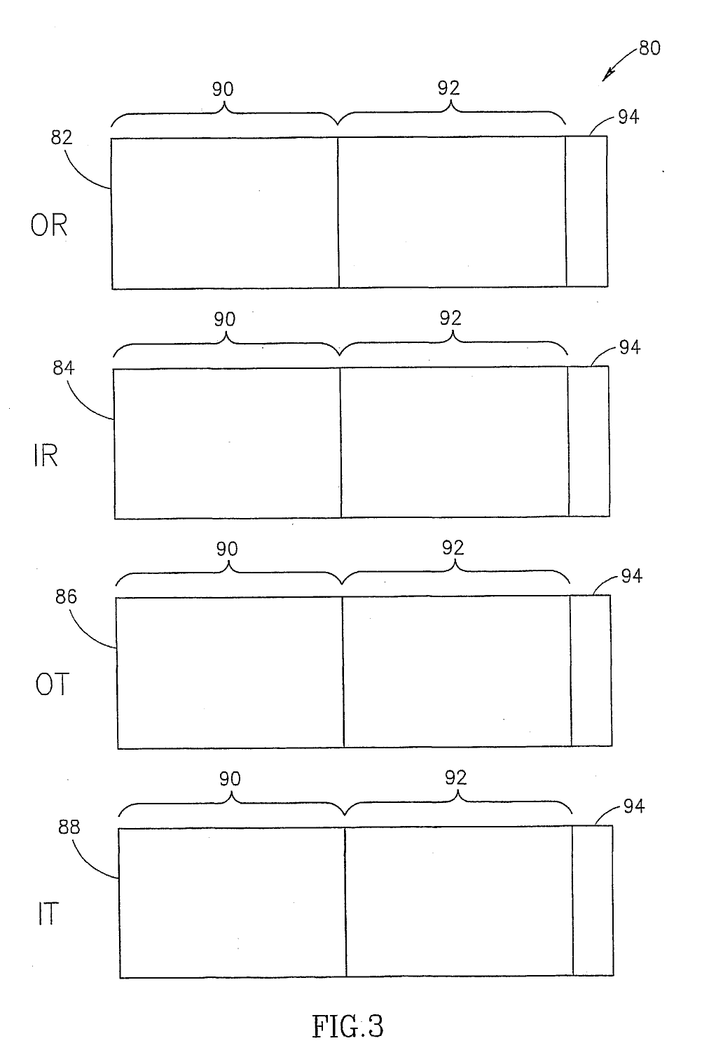

FIG. 3 is a schematic illustration of a table array 80 used by a transparency module 46 of proxy server 22, in accordance with an embodiment of the present invention. Table array 80 is used for replacing the fields of packets provided to proxy module 44 and/or transmitted by proxy server 22. In some embodiments of the invention, table array 80 comprises an outbound reception (OR) table 82 for packets received through outbound port 30, an inbound reception (IR) table 84 for packets received through inbound port 32, an outbound transmission (OT) table 86 for packets received from proxy module 44 for transmission through outbound port 30 and an inbound transmission (IT) table 88 for packets received from proxy module 44 for transmission through inbound port 32. Each of tables 82, 84, 86 and 88 comprises key fields 90 which are compared to received packets in order to find a matching entry and replacement fields 92 which include values which are to be inserted into matching packets.

In some embodiments of the invention, key fields 90 include source and destination IP address fields and source and destination port fields. Optionally, key fields 90 of at least one of tables 82, 84, 86 and 88 include a protocol field. Alternatively, key fields 90 comprise only the source and/or destination ports of the packets. In some embodiments of the invention, replacement fields 92 of tables 82, 84, 86 and 88 include source and destination replacement IP address fields and source and destination replacement port fields. Alternatively, some of the tables include less or more replacement fields according to the specific replacement requirements of the packets.

Optionally, replacement fields 92 may receive a special value which indicates that no replacement is required. Alternatively, when no replacement is required, the original value of the packets of the entry are placed in the respective replacement fields. In some embodiments of the invention, tables 82, 84, 86 and 88 include an interest field 94 which indicates whether packets matching the entry should be provided to proxy module 44, i.e., whether the packets are interesting. Alternatively or additionally, tables 82, 84, 86 and/or 88 include other handling related columns which relate to other handling issues of the packets.

The use of four tables (82, 84, 86 and 88) simplifies the operation of transparency module 46 as each direction from which a packet is received has a respective separate table. Alternatively, two tables, e.g., one table for packets from ports 30 and 32 and a second table for packets from proxy server 44, are used. Further alternatively, a single table is used for all the packets. Optionally, in these alternatives, key fields 90 include an additional field which identifies the direction from which the packet was received. Optionally, the direction is identified based on the MAC address of the packet, for packets received from one of ports 30 and 32, and according to the IP and/or MAC destination address for packets from proxy module 44.

In some embodiments of the invention, tables 82, 84, 86 and 88 are implemented as hash tables in which the index is equal to a function of one or more of key fields 90. Optionally, some or all of the tasks performed by table array 80 are performed by a script, function or any other data structure.

Table 1 is an exemplary value setup of the entries in table array 80 for packets received through outbound port 30 and responses thereto received through inbound port 32, in accordance with an embodiment of the present invention.

TABLE 1

| Table | S_IP | S_port | D_IP | D_port | r_S_IP | r_S_port | r_D_IP | r_D_port |
|---|---|---|---|---|---|---|---|---|
| OR | sIP | s_port | dIP | d_port | | p_port | | |
| IT | f_gsp | p_port | f_ws | d_port | sIP | | dIP | |
| IR | dIP | d_port | sIP | p_port | f_ws | | f_gsp | |
| OT | dIP | d_port | sIP | p_port | | | | s_port |

Packets received through outbound port 30 carry a source IP address sIP, a source port s_port, a destination IP address dIP (for example an IP address of a Web farm of local network 20), and a destination port d_port. When a packet, for example an HTTP request packet, is received, transparency module 46 finds a respective entry in outbound reception (OR) table 82 and accordingly replaces the source port (s_port) with the pseudo port (p_port) which appears in a replacement source port (r_S_port) column of the replacement fields 92. The packet with the pseudo port is then provided to proxy module 44 for processing. In some embodiments of the invention, proxy module 44 is configured to relate to the destination IP address (dIP) of the packet as the IP address of proxy server 22 for outbound port 30.

The changing of the source port to the pseudo port value (p_port) allows easy identification of the packets belonging to the session of the packet, especially when proxy module 44 may change other fields of the packets it processes. Optionally, proxy module 44 is configured not to change the values of port fields of packets it processes. Alternatively or additionally, transparency module 46 changes one or more other fields which are not changed (or are very rarely changed) by proxy module 44. Possibly, proxy module 44 is specifically configured not to change these one or more fields. Further alternatively or additionally, transparency module 46 adds a time stamp or any other identification number to packets provided to proxy module 44 and/or forwarded to the local network.

Proxy module 44 processes the packet according to its specific tasks and optionally provides transparency module 46 with one or more packets generated responsive to the provided packet. In some embodiments of the invention, proxy module 44 provides the packets with a source IP address (f_gsp) which is an IP address configured into proxy module 44 as the IP address of proxy server 22 for inbound port 32 and a destination address (f_ws) which is an IP address configured into proxy module 44 as the address of the Web farm of local network 20.

The packet from proxy module 44 is compared to inbound transmission table (IT) 88 and accordingly the source IP address (f_gsp) and the destination IP address (f_ws) given to the processed packet by proxy module 44 are changed to the source and destination addresses sIP and dIP of the original packet, in order to remove the address changes of proxy module 44. The HTTP request packet is then forwarded (66) through inbound port 32. A response HTTP packet received through inbound port 32 responsive to the request packet is compared to inbound reception (IR) table 84 and accordingly the source and destination IP addresses of the response packet are replaced to the source IP address (f_gsp) and the destination IP address (f_ws) given to the processed request packet by proxy module 44. Thus, proxy module 44 is able to easily correlate between the request packet and the response packet, without being aware of the transparency of proxy server 22. The response packet is processed by proxy module 44 and a processed response packet is returned to transparency module 46 which compares the packet to outbound transmission (OT) table 86 and accordingly replaces the destination port which is equal to the pseudo port(p_port) to the original source port (s_port) of the request packet.

Alternatively, to replacing the IP addresses by proxy module 44 and reversing the changes by transparency module 46, as described above, the code of proxy module 44 is changed so as not to change the addresses. This, however, requires changing the code of proxy module 44, a task which may require extensive work.

It is noted that if the packet received through outbound port 30 is not interesting, the packet is not provided to proxy module 44 and therefore the comparison to IT table 88 is not performed. Likewise, the response packet received through inbound port 32 is not provided to proxy server 44 and therefore the comparison to OT table 86 is not performed. Instead, the entry in IR table 84 has the form described in table 1 for OT table 86.

Alternatively to transmitting packets to the local network, through inbound port 30, with the pseudo port (p_port) value, the original port value is returned in the comparison to IT table 88 and in the comparison to IR table 84 the pseudo port value (p_port) is re-inserted. In this alternative the pseudo ports are used only internally to proxy server 22 and are not viewed by external network entities.

If a matching entry does not exist in OR table 82 for a packet received from outbound port 30, a pseudo source port (p_port) value is chosen, as described hereinbelow, and an entry is created in OR table 82 which identifies the session of the packet and states the chosen pseudo port (p_port), as is shown in table 1. In some embodiments of the invention, substantially concurrently with creating the entry in OR table 82, entries are created in tables 84, 86 and 88 for the same session, based on information configured into transparency module 46 on the operation of proxy module 44. Specifically, dIP is the IP address of the local network to which clients send packets directed to the local network, f_ws is the IP address to which proxy module 44 is configured to forward packets directed to the local network (with destination address dIP) and f_gsp is the IP address with which proxy module 44 identifies proxy server 22. Alternatively or additionally, transparency module 46 communicates with proxy module 44 to receive the required information.

Further alternatively or additionally, transparency module 46 periodically provides proxy module 44 with test packets, and according to the response of proxy module 44, transparency module 46 determines the behavior of proxy module 44. Further alternatively or additionally, transparency module 46 provides proxy module 44 with packets in a consecutive manner such that a following packet is not provided before a response to a previous packet is received.

Alternatively, at the same time as the entry in OR table 82 is created, a respective entry is created also in OT table 86. When the processed packet is received from proxy module 44, respective entries are created in IT table 88 and IR table 84, according to the changed addresses in the received packet.

Table 2 is an exemplary value setup of the entries in table array 80 for packets received through inbound port 32 and responses thereto received through outbound port 30, in accordance with an embodiment of the present invention.

TABLE 2

| Table | S_IP | S_port | D_IP | D_port | r_S_IP | r_S_port | r_D_IP | r_D_port |
|---|---|---|---|---|---|---|---|---|
| IR | sIP | s_port | dIP | d_port | | p_port | | |
| OT | f_gsp | p_port | dIP | d_port | sIP | | | |
| OR | dIP | d_port | sIP | p_port | | | f_gsp | |
| IT | dIP | d_port | sIP | p_port | | | | s_port |

Packets received through inbound port 32 carry a source IP address sIP, a source port s_port, a destination IP address dIP, and a destination port d_port. When a packet is received, transparency module 46 finds a respective entry in inbound reception (IR) table 84 and accordingly replaces the source port (s_port) with the pseudo port (p_port) which appears in a replacement source port (r_S_port) column of the replacement fields 92. The packet with the pseudo port is then provided to proxy module 44 for processing.

The processed packet (or packets generated responsive to the provided packet) from proxy module 44 is compared to outbound transmission (OT) table 86 and accordingly the source IP address (f_gsp) given to the processed packet by proxy module 44 is changed to the source address sIP of the original packet, in order to remove the address changes of proxy module 44. The packet is then forwarded (66) through outbound port 30. A response packet received through outbound port 30 responsive to the packet is compared to outbound reception (OR) table 82 and accordingly the destination IP address of the response packet is replaced to the source IP address (f_gsp) given to the processed request packet by proxy module 44. Thus, proxy module 44 is able to easily correlate between the request packet and the response packet, without being aware of the transparency of proxy server 22. The response packet is processed by proxy module 44 and a processed response packet is returned to transparency module 46 which compares the packet to inbound transmission (IT) table 88 and accordingly replaces the destination port, which is equal to the pseudo port(p_port), to the original source port (s_port) of the request packet.

It is noted that if the packet received through outbound port 30 is not interesting, the packet is not provided to proxy module 44 and therefore the comparison to OT table 86 is not performed. Likewise, the response packet received through outbound port 30 is not provided to proxy server 44 and therefore the comparison to IT table 88 is not performed. Instead, the entry in OR table 82 has the form described in table 2 for IT table 88.

In some embodiments of the invention, variations as described above with reference to table 1 are applied also to the packets originating from the local network, which are handled in accordance with table 2.

Alternatively, proxy server 22 does not support the transmission of packets on sessions created at the initiative of the local network. Further alternatively, proxy server 22 does not consider packets of such sessions as interesting.

Table 3 is an exemplary value setup of the entries in table array 80 for packets generated by proxy module 44 or by other processes on proxy server 22 and transmitted through outbound port 30 and responses thereto received through outbound port 30, in accordance with an embodiment of the present invention.

TABLE 3

| Table | S_IP | S_port | D_IP | D_port | r_S_IP | r_S_port | r_D_IP | r_D_port |
|---|---|---|---|---|---|---|---|---|
| OT | sIP | s_port | dIP | d_port | | p_port | | |
| OR | dIP | d_port | sIP | p_port | | | | s_port |

Packets generated by proxy module 44, or other processes of proxy server 22, for transmission through outbound port 30, carry a source IP address sIP, a source port s_port, a destination IP address dIP, and a destination port d_port. As described above, sIP is a pseudo source address which proxy server 22 is configured to use, for example an address of local network 20. The generated packet is provided to transparency module 46 which finds a respective entry in outbound reception (OT) table 86 and accordingly replaces the source port (s_port) with the pseudo port (p_port) which appears in a replacement source port (r_S_port) column of the replacement fields 92. The packet with the pseudo port is then forwarded through outbound port 30.

If an entry does not exist, transparency module 46 creates a respective entry in OT table 86 and OR table 82. Optionally, before creating the entry, transparency module 46 verifies that the process requesting to transmit the packet is entitled to do so, and if not the packet is discarded. Alternatively or additionally, transparency module 46 verifies that the process requesting to transmit the packet is entitled to receive incoming packets and only if so, an entry is created for the packet in OR table 86. It is noted that the creation of the entry in OR table 82 allows transmission of packets to the process for which the entry was created.

A response packet received through outbound port 30 responsive to the packet is compared to outbound reception (OR) table 82. If a match is not found in the table, the packet is handled as described hereinabove as directed to a different entity in local network 20. If a match is found, the destination port of the response packet which is equal to the pseudo port (p_port) is changed to the original source port (s_port) of the generated packet, and the packet is provided to the TCP stack which passes it to the process to which the session belongs according to the destination port of the packet. Thus, a process on proxy server 22 can only receive packets belonging to a session which was created by the process. This makes breaking in to proxy server 22 much harder.

Table 4 is an exemplary value setup of the entries in table array 80 for packets generated by proxy module 44 of proxy server 22 for transmission through inbound port 32 and responses thereto received through inbound port 32, in accordance with an embodiment of the present invention.

TABLE 4

| Table | S_IP | S_port | D_IP | D_port | r_S_IP | r_S_port | r_D_IP | r_D_port |
|---|---|---|---|---|---|---|---|---|
| IT | f_gsp | s_port | f_ws | d_port | spoofIP | p_port | ws_IP | |
| IR | ws_IP | d_port | spoofIP | p_port | f_ws | | f_gsp | p_port |

Packets generated by proxy module 44 for transmission through inbound port 32 carry a source IP address f_gsp, a source port s_port, a destination IP address f_ws, and a destination port d_port. As described above, f_gsp is a pseudo source address and f_ws is a pseudo destination address which proxy module 44 is configured to use. The generated packet is provided to transparency module 46 which finds a respective entry in inbound reception (IT) table 88 and accordingly replaces the source address f_gsp to a pseudo source address spoofIP which transparency module 46 wants the packet to be transmitted with, for transparency reasons. In addition, the destination address f_ws with which proxy module 44 is configured, is changed to the real IP address of the destination web server, i.e., ws_IP. Optionally, proxy module 44 is configured to use the destination address f_ws and not the real address ws_IP because proxy server 44 is configured to relate to ws_IP as to its own address.

Optionally, the source port s_port is also changed to a pseudo source port (p_port). Alternatively, the source port is not changed, as the packets matching the description of table 4 may be identified without the use of a unique source port for identification purposes.

A response packet received through inbound port 32, responsive to the generated packet, is compared to inbound reception (IR) table 84 and accordingly the original addresses and destination port value are reinstalled.

In some embodiments of the invention, transparency module 46 generates packets to be transmitted in addition to, or instead of, the packets generated by proxy module 44. These packets are generated already with the IP addresses with which they are to be transmitted according to the above discussion in relation to tables 3 and 4.

In some embodiments of the invention, the pseudo source port values are taken from a range of port values which transparency module 46 uses for marking purposes. Optionally, if a packet carrying a port number from the predetermined range is received by proxy server 22, the port number is changed to a different number to prevent identification of packets of two different sessions as belonging to the same session.

In some embodiments of the invention, the entries of table array 80 are erased a predetermined time after their creation. Optionally, each entry has a time-out field which is periodically decremented. When the value of the time-out field reaches zero, the entry is erased from table array 80. In some embodiments of the invention, when a packet with the TCP FIN or RST bit set (meaning the session is being closed), the time-out field is given a value close to zero such that the entry will be erased within a short time period.

FIG. 4 is a flowchart of the handling (70) of ARP packets, in accordance with an embodiment of the present invention. If (150) the ARP packet is a request, transparency module 46 consults a transparency ARP cache, which is used to perform cache spoofing, to determine whether (152) module 46 has the MAC address requested in the ARP request. The transparency ARP cache may be used for both ports 30 and 32 or may include separate sub-caches for each of the ports. If the requested address is included in the cache, transparency module 46 responds by transmitting (154) an ARP response which includes the MAC address of the port of proxy server 22 through which the request was received. If (152) the transparency ARP cache does not have the required MAC address, transparency module 46 transmits (156) an ARP request for the required MAC address through the port (30 or 32) opposite to the port through which the original request was received. If (150) and when a response to the request is received, transparency module 46 updates (158) its ARP cache and transmits (154) an ARP response, as described above.

In some embodiments of the invention, when proxy module 44 generates a packet to be transmitted, the MAC address is determined by a TCP/IP stack of proxy server 22. In the absence of the required MAC address, the TCP/IP stack generates an ARP request to be transmitted through one of ports 30 or 32 of proxy server 22. In some embodiments of the invention, transparency module 46 intercepts ARP requests generated by the TCP/IP stack. If the ARP request is directed to be forwarded through inbound port 32 but is not directed to a known Web server, the packet is discarded. If the required MAC address is in the transparency ARP cache of transparency module 46 the required MAC address is provided to the TCP/IP stack. Otherwise, transparency module 46 changes the IP source address of the ARP request to an address which coincides with the transparent operation of proxy server 22. For example, if the ARP request is transmitted through outbound port 30, the packet is transmitted with a source IP address of one of the web servers of the local network and if the packet is transmitted through inbound port 32 the packet is transmitted with a pseudo source address as described hereinabove.

In some embodiments of the invention, instead of a single transparent proxy server 22, a transparent proxy farm including a plurality of transparent proxy servers is used, as is now described. The servers in the transparent proxy farm operate in coordination distributing between them the handling of the packets passing through them.

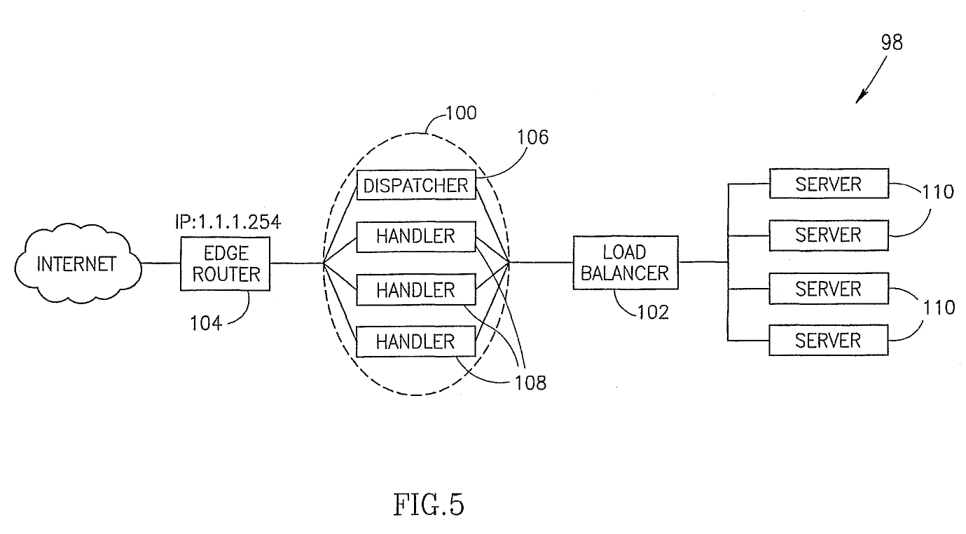

FIG. 5 is a schematic block diagram of a Web site server farm 98 including a transparent proxy farm 100, in accordance with an embodiment of the present invention. Although FIG. 5 shows transparent proxy farm 100 in conjunction with Web site server farm 98, proxy farm 100 may be used with substantially any other network. Server farm 98 comprises, for example, a plurality of Web servers 110 and a load balancer 102 which distributes packets directed to Web farm 98 between Web servers 110. An edge router 104 receives packets from the Internet, designated in FIG. 5 by a cloud 112. As shown in FIG. 5, proxy farm 100 is situated between edge router 104 and load balancer 102. Alternatively, proxy farm 100 may be located between edge router 104 and Internet 112 or between load balancer 102 and Web servers 110. Proxy farm 100 comprises a dispatcher 106 which receives all the packets passing between load balancer 102 and edge router 104. In addition, proxy farm 100 comprises a plurality of handlers 108 which process packets in accordance with the tasks of proxy farm 100. Generally, packets received by server farm 100 are handled in a manner similar to that described above, in relation to server proxy 22.

In some embodiments of the invention, dispatcher 106 and handlers 108 are connected in parallel between load balancer 102 and edge router 104, such that dispatcher 106 and all of handlers 108 receive in layer-2 all the packets transmitted between load balancer 102 and edge router 104. Alternatively or additionally, one or more of handlers 108 are connected only to dispatcher 106.

In some embodiments of the invention, dispatcher 106 also operates as a handler. Optionally, some or all of handlers 108 have the ability to perform as a dispatcher, and a distributed protocol is used to select periodically, or upon failure of the current dispatcher, one of handlers 108 to perform as dispatcher. In some embodiments of the invention, handlers 108 comprise a common memory unit which hosts a dispatching table, so as to allow smooth transfer of the dispatcher task between handlers. Alternatively or additionally, during a short period after receiving the task of dispatcher, the handler performing as dispatcher creates entries for all packets even if they belong to the middle of a session.

Alternatively, dispatcher 106 does not include a handler. Optionally, transparent proxy farm 100 comprises a backup dispatcher, either one of handlers 108 or a separate unit, which performs the tasks of dispatcher 106 if the dispatcher malfunctions.

In some embodiments of the invention, dispatcher 106 determines, for each packet it receives, whether the packet is interesting, i.e., should be processed by a handler 108 of proxy farm 100. Optionally, uninteresting packets are forwarded directly to their destination by dispatcher 106, and dispatcher 106 performs the required changes to the packet as described above with reference to FIG. 3. Alternatively, uninteresting packets are forwarded to a handler 108 to perform the required changes.

For interesting packets, dispatcher 106 selects a handler 108 to process the packet, and the packet is forwarded to the selected handler 108. Optionally, the packet is forwarded by dispatcher 106 to the selected handler 108, through the port of dispatcher 106 through which the packet was received. Thus, handler 108 receives the packet from the direction the packet originally originated. Alternatively, the packet is forwarded by dispatcher 106 to the selected handler 108, through the port of dispatcher 106 opposite to the port through which the packet was received. Further alternatively, the packet is forwarded through a randomly selected port or based on load considerations. Optionally, the receiving handler. 108 determines the direction from which the packet was received based on the IP destination and/or source address of the packet and/or the source MAC address of the packet.

In some embodiments of the invention, dispatcher 106 has a dispatching table in which packet sessions are listed with the respective handler 108 to which they are to be forwarded and the pseudo port which they are assigned. The selection of handler 108 may be performed using substantially any load balancing method known in the art. Optionally, dispatcher 106 supports a plurality of load balancing methods from which the user may choose a most desired method.

In some embodiments of the invention, each handler 108 manages a separate table array, similar to table array 80 described above. Alternatively or additionally, handlers 108 manage a common table array in a common memory.

If the dispatcher selects itself to handle the packet, the packet is possibly handled as described above with reference to proxy server 22. If a different handler is selected to handle the packet, dispatcher 106 optionally performs the tasks of transparency module 46 as described above and forwards the packet to the selected handler 108 to perform the tasks of proxy module 44 as described above. Optionally, the post-processing packet changing (64, FIG. 2) is performed by the selected handler 108. Alternatively, the packet is returned to dispatcher 106 to perform the post-processing.

Alternatively, dispatcher 106 forwards the packet, substantially without changes, to the selected handler 108 which performs the tasks of transparency module 46 in addition to the tasks of proxy module 44. Optionally, in this alternative, dispatcher 106 determines for packets received from edge router 104, a pseudo port with which the packet is to be forwarded to server farm 98. In some embodiments of the invention, dispatcher 106 then changes the destination MAC address of the packet to the MAC address of the selected handler 108. Optionally, dispatcher 106 forwards the packets to the selected handler 108 with a pseudo source MAC address which includes information which dispatcher 106 wants to transfer to handler 108 in relation to the packet. Optionally, the source MAC address is changed to include the selected pseudo port. The source MAC address may be used for information transfer, because the only entity which transmits packets to handlers 108 is the dispatcher.

In some embodiments of the invention, the receiving handler 108 generates entries of a table array 80 of the handler, changes the source port of the packet to the pseudo port value in the source MAC address and provides the packet to the proxy module 44 of the handler.

In some embodiments of the invention, each pseudo port number is used only for a single session. Alternatively, the same pseudo port number may be used for a plurality of sessions provided they may be differentiated by a different key field, e.g., they have different client IP addresses.

Packets generated by server farm 98 in response to client packets, are forwarded to dispatcher 106 by load balancer 102. Dispatcher 106 determines, based on its table, the handler 108 which handled the client packet, and the response packet is forwarded to the same handler.

In some embodiments of the invention, ARP packets and other RIP packets are handled only by the dispatcher 106, in a manner similar to that described above in relation to server proxy 22.

In some embodiments of the invention, handlers 108 verify, in addition to or instead of verification performed by dispatcher 106, that packets directed to them have a destination IP address of a legal Web server of farm 98. This is performed to prevent hackers from fiddling with the configuration of handlers 108.

In some embodiments of the invention, dispatcher 106 and handlers 108 are separate switches or computers which do not have a common CPU. Alternatively or additionally, proxy farm 100 comprises a computer or switch with a central CPU and a plurality of cards which operate as handlers.

Alternatively to using a dispatcher 106, proxy farm 100 comprises a plurality of handlers which each receives all the traffic to proxy farm 100. Each handler is assigned a portion of the traffic and discards the rest of the traffic which is not assigned to the specific handler. For example, each handler may take care of packets having inbound addresses from a specific group of inbound IP addresses.

In some embodiments of the invention, modules 44 and 46 comprise software modules running on a single processor. Alternatively or additionally, modules 44 and 46 comprise hardware modules, e.g., switches. In an exemplary embodiment of the invention, module 44 comprises a software module running on a processor and transparency module 46 comprises a PCA card coupled to the processor.

It is noted that although the above described embodiments relate to a proxy server, some particular embodiments of the invention may relate to other mediation tools, including firewalls, QoS servers, and various types of proxy servers including caching servers. Furthermore, although specific network configurations were shown as examples in FIGS. 1 and 5, the transparent proxy servers and mediation tools of the present inventions may be used with substantially any network configuration.

It is further noted that although the present invention has been described in relation to the TCP/IP protocol suite, some embodiments of the invention may be implemented with relation to other packet based transmission protocols, such as, for example IPX, DECNET and the ISO protocols. Furthermore, although the above embodiments relate to the Ethernet link layer, the present invention may be used with substantially any layer-2 protocol including, but not limited to, Frame relay, point to point modem, ISDN, ASDL and ATM.

It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of handling packets by a proxy server, comprising:
receiving a packet, requesting to establish a connection of a connection based protocol, not carrying an IP address of the proxy server in an IP destination address field of the packet; and
establishing a correction between the proxy server and a source of the received packet, as listed in the source IP address of the received packet.

2. A method according to claim 1, comprising establishing a connection between the proxy server and a destination of the received packet, as listed in the destination IP address of the received packet.

3. A method according to claim 1, comprising receiving one or more additional packets belonging to the same session as the packet requesting establishment of the connection.

4. A method according to claim 3, wherein the received one or more additional packets carry application layer data and comprising altering the application layer data and forwarding the altered data to the destination of the one or more received packets.

5. A method according to claim 4, wherein altering the data comprises leaving at least some of the received application layer data unaltered.

6. A method according to claim 4 or claim 5, wherein altering the data comprises correcting spelling or grammatical errors in the application layer data.

7. A method according to any of claims 4-6, wherein forwarding the altered data to the destination of the one or more packets comprises forwarding in one or more packets carrying at least one different port field value different than in the received one or more additional packets.

8. A method according to any of claims 4-7, wherein forwarding the altered data to the destination of the one or more packets comprises forwarding in one or more packets carrying the same destination IP address as the received packet requesting establishment of the connection.

9. A method according to any of the preceding claims, wherein the proxy server comprises a transparency module and a proxy module and wherein receiving the packet requesting to establish a connection comprises receiving by the transparency module, modifying one or more fields of the packet by the transparency module and providing the modified packet to the proxy module of the proxy server.

10. A method according to claim 9, wherein the transparency module modifies one or more of the IP address fields and port fields of the packet.

11. A method according to claim 10, wherein the transparency module modifies the source port field of the packet.

12. A method according to any of the preceding claims, wherein the request packet is received through a physical port of the proxy server, which does not have a configured IP address which is used as a source IP address for packets transmitted through the physical port.

13. A method of handling packets by a proxy server, comprising:
receiving, by the proxy server, one or more packets of a specific session, not carrying an IP address of the proxy server in their IP destination address field;
altering a portion of the application layer data of the received one or more packets, while leaving at least some of the data intact; and
forwarding the altered application layer data to the destination of the received one or more packets as identified by the IP destination address field of the one or more received packets.

14. A method according to claim 13, wherein forwarding the altered application layer data comprises forwarding in packets carrying the same IP addresses as the received one or more packets.

15. A method according to claim 13 or claim 14, wherein forwarding the altered application layer data comprises forwarding in packets carrying the same time to live (TTL) value as the received one or more packets.

16. A method according to any of claims 13-15, wherein forwarding the altered application layer data comprises forwarding in packets having at least one different port field value different from the value in the respective field in the received one or more packets.

17. A method according to any of claims 13-16, wherein altering the portion of the application layer data comprises replacing an erroneous portion of a Web page by a replacement portion.

18. A method of handling packets by a proxy server, comprising:
receiving, by the proxy server, one or more packets of a specific session, not carrying an IP address of the proxy server in their IP destination address field;
altering at least one of the port fields of the received one or more packets; and
forwarding the altered one or more packets to the destination of the received one or more packets as identified by the IP destination address field of the one or more received packets.

19. A method according to claim 18, wherein forwarding the altered one or more packets comprises forwarding with the same IP addresses as the received one or more packets.

20. A method according to claim 18 or claim 19, wherein forwarding the altered one or more packets comprises forwarding the altered packets with the same time to live (TTL) value as the received one or more packets.

21. A method according to any of claims 18-20, wherein forwarding the altered one or more packets comprises forwarding in accordance with a splicing procedure.

22. A method of converting a mediation tool, located on a network path, into a transparent tool, comprising:
providing a packet transmitted on the path, to a mediation module of the tool;
receiving from the mediation module one or more packets generated in response to the provided packet; and
altering one or more fields of the one or more packets received from the mediation module, so that the altered fields have the same values as the packet provided to the mediation module.

23. A method according to claim 22, comprising receiving the packet from the path, the received packet from the path having a destination IP address not belonging to the mediation tool.

24. A method according to claim 22 or claim 23, comprising altering one or more fields of the packet provided to the mediation module.

25. A method according to claim 24, wherein altering the one or more fields comprises inserting to the packet an identification value which is used in identifying the one or more packets generated by the mediation tool in response to the provided packet.

26. A method according to claim 25, wherein inserting an identification value comprises changing a source port field of the provided packet.

27. A method according to any of claims 24-26, wherein altering the one or more fields comprises altering one or more fields to values expected by the mediation tool, such that the mediation tool operates without being aware of the transparency.

28. A method of handling packets passing along a path by a plurality of mediation tools, comprising:
providing, by each of the plurality of mediation tools, at least some of the packets passing along the path and not carrying an IP address of any of the mediation tools in their IP destination address field, to a layer four or above module of the mediation tool; and
forwarding packets carrying the same destination IP address as the provided packets, responsive to at least some of the provided packets.

29. A method according to claim 28, wherein forwarding packets carrying the same destination IP address as the provided packets comprises forwarding at least one of the packets with the same application layer data as a provided packet.

30. A method according to claim 28 or claim 29, wherein forwarding packets carrying the same destination IP address as the provided packets comprises forwarding at least one of the packets with some application layer data from a provided packet and some application layer data not included in a provided packet of the same session.

31. A method according to any of claims 28-30, wherein forwarding packets carrying the same destination IP address as the provided packets comprises forwarding packets having at least one port value different from the respective provided packet.

32. A method according to any of claims 28-31, wherein providing, by each of the is mediation tools, at least some of the packets to a layer four or above module, comprises receiving all the packets passing on the path by each of the mediation tools and each mediation tool determining which packets to provide to its layer four or above module, responsive to a layer 3 or above content of the packets.

33. A method according to claim 32, wherein determining, by each of the mediation tools, which packets to provide to the layer four or above module comprises determining responsive to the source or destination IP address of the packet.

34. A method according to claim 32, wherein determining, by each of the mediation tools, which packets to provide to the layer four or above module comprises determining responsive to predetermined rules.

35. A method according to any of claims 28-31, wherein providing, by each of the mediation tools, at least some of the packets to a layer four or above module, comprises receiving all the packets passing on the path by a dispatcher, determining by the dispatcher whether the packet requires handling and if required selecting one or more of the mediation tools to perform the handling and forwarding the packet to the selected mediation tool.

36. A method according to claim 35, wherein forwarding the packet to the selected mediation tool comprises forwarding in layer 2.

37. A method according to claim 36, wherein forwarding the packet to the selected mediation tool comprises forwarding with a source MAC address not belonging to the dispatcher.

38. A method according to any of claims 35-37, wherein the dispatcher comprises one of the mediation tools.

39. A method according to claim 38, comprising selecting a mediation tool to operate as the dispatcher using a distributed algorithm.

40. A transparent mediation farm, comprising:
a plurality of mediation tools which provide at least some of the packets they receive to a layer four or above module of the mediation tool for processing and which forward packets carrying the same destination IP address as the provided packets, responsive to at least some of the provided packets; and
communication links which connect the plurality of mediation tools.

41. A farm according to claim 40, wherein at least one of the mediation tools may operate as a dispatcher which receives packets passing on the communication links, determines which of the packets should be forwarded to one or more of the mediation tools and forwards the packets to the respective mediation tools.

42. A farm according to claim 40, wherein at least one of the mediation tools comprises a proxy server.

43. A farm according to claim 40, wherein all the mediation tools perform the same tasks.

44. A farm according to claim 40, wherein at least one of the mediation tools performs at least one different task than one other of the mediation tools.

45. A farm according to claim 40, wherein at least one of the mediation tools generates packets with a source address not belonging to the mediation tool or to any of the packets recently received by the mediation tool.

46. A farm according to claim 40, wherein at least one of the mediation tools is configured with an IP address which is not used in any of the packets forwarded by the mediation tool.

47. A transparent mediation tool, comprising:
a mediation module; and
a transparency module which receives packets from the mediation module, alters one or more IP address fields of the received packets so that the IP addresses of the altered packets do not reveal that the packets were handled by the mediation module and forwards the altered packets on a communication link.

48. A tool according to claim 47, wherein the mediation module comprises a proxy server module.

49. A tool according to claim 47 or claim 48, wherein the mediation module changes at least some of the application layer data of the packets.

50. A tool according to any of claims 47-49, wherein the transparency module receives packets transmitted on the communication link and provides the packets from the link to the mediation tool, and wherein the transparency module alters the IP addresses of packets received from the mediation tool to the IP addresses of packets of the same session provided to the mediation tool.

51. A tool according to claim 50, wherein the transparency module alters at least one of the port fields of at least some of the packets provided to the mediation module.

52. A tool according to any of claims 47-51, wherein the transparency module comprises a software module.

53. A tool according to any of claims 47-51, wherein the transparency module comprises a hardware module.

54. A proxy server, comprising:
an input interface which receives a packet, requesting to establish a connection of a connection based protocol, not carrying an IP address of the proxy server in an IP destination address field of the packet; and
a proxy module which establishes a connection between the proxy server and a source of the received packet, as listed in the source IP address of the received packet.

55. A proxy server according to claim 54, wherein the proxy module establishes a connection between the proxy server and a destination of the received packet, as listed in the destination IP address of the received packet.

56. A proxy server, comprising:
an input interface which receives one or more packets of a specific session, not carrying an IP address of the proxy server in their IP destination address field; and
a proxy module which alters a portion of the application layer data of the received one or more packets, while leaving at least some of the data intact; and
an output interface which forwards the altered application layer data to the destination of the received one or more packets as identified by the IP destination address field of the one or more received packets.

57. A proxy server according to claim 56, wherein the proxy module manages a list of packet sessions which it is interested in receiving and packets received by the proxy module are compared to the list to determine whether they are directed to the proxy module.
